(19) United States
(12) Patent Application Publication
(10) Pub. No.: US 2012/0115734 A1
(43) Pub. Date: May 10, 2012

(54) IN SILICO PREDICTION OF HIGH EXPRESSION GENE COMBINATIONS AND OTHER COMBINATIONS OF BIOLOGICAL COMPONENTS

(76) Inventors: Laura Potter, Cary, NC (US); Michael Nuccio, Durham, NC (US); Rex Dwyer, Raleigh, NC (US)

(21) Appl. No.: 12/939,586

(22) Filed: Nov. 4, 2010

(51) Int. Cl. C40B 10/00; C40B 60/00

(52) U.S. Cl. 506/1; 506/33

(57) ABSTRACT

Various systems and methods for selecting candidate biological components and/or combinations of biological components that affect a biological process are described. For example, a computing device may use a computer model to simulate the biological process and predict a phenotypic outcome. In this manner, the impact of candidate components and combinations may be determined using the computer model. The computing device may determine optimal characteristics such as expression levels of biological components that result in a desirable phenotypic outcome of the biological process as predicted by the computer model. The computing device may perform sensitivity analysis around the optimal characteristics. The sensitivity analysis may be used to determine whether the candidate combinations are robust across a range of the optimal characteristics. The computing device may select various candidate components and combinations based on the sensitivity analysis and the predicted phenotypic outcome.

### FIELD OF THE INVENTION

The disclosure relates to predicting biological components that affect biological processes and more particularly to using a model of a biological process to determine components that are predicted to cause a desirable phenotypic outcome of the biological process.

### BACKGROUND OF THE INVENTION

Conventional lead discovery efforts typically focus on a single biological component to improve a phenotypic outcome. For example, conventional systems may focus on finding single genes to improve traits in various crop species. In particular, various conventional systems focus on single gene discovery to improve complex traits such as yield in maize, oftentimes with limited success. This limited success is attributable at least in part to the contribution of a single component such as a gene on a biological process such as a complex metabolic or gene regulatory network being too small to significantly impact the trait. For example, over-expressing or knocking down the single gene may not have a significant impact on the metabolic or gene regulatory network because the single gene acts in combination with other genes.

This problem may also apply to other biological and/or chemical reactions where multiple components are responsible for a particular outcome such that modifying a single component alone may not have an effect on the particular outcome. For example, multiple enzymes affecting a biological process such as a biochemical reaction may be sufficiently complex that attenuating various characteristics of a single enzyme may not have a significant effect on the biochemical reaction.

Conventional systems also fail to determine optimal characteristics of single or combinations of components that lead to locally or globally optimal phenotypic outcomes as predicted by a computer model. In other words, conventional systems fail to optimize characteristics so that a computer model predicts locally or globally maximized (or minimized) phenotypic outcomes.

What is needed is to be able to identify single and/or combinations of components that can affect a phenotypic outcome of a biological process. For example, what is needed is to be able to determine which genes in combination with other genes could be over-expressed and/or knocked down to improve a trait. Furthermore, conventional discovery techniques may focus on finding only optimal characteristics that typically fail to allow for deviation from the predicted optima. However, typically such optima are, for various reasons, not achieved in vitro or in vivo. Thus, real-world experimentations may not achieve predicted results because optima may not be achieved. Thus, what is needed is to be able to determine optima for single components or combinations of components that are robust over a range across each optimum. These and other problems exist.

### SUMMARY OF THE INVENTION

Various systems, computer program products, and methods for using a model of a biological process to predict candidate components such as genes and/or combinations of components such as gene combinations that enhance the biological process are described herein.

According to various implementations of the invention, a method for selecting candidate combinations of components that each impact a biological process may include, for each of a plurality of combinations, where each of the plurality of combinations comprises a plurality of components, each of the plurality of components affecting, directly or indirectly, a phenotypic outcome of the biological process, determining an optimal characteristic for each of the plurality of components based on whether the computer model predicts a global or local optimum for the phenotypic outcome using the optimal characteristic. For each of the plurality of combinations, the method may include determining a sensitivity of each of the plurality of combinations around the optimal characteristics associated with each of the corresponding plurality of components using the computer model. The method may further include selecting one or more of the plurality of combinations based on the simulated phenotypic outcome and the determined sensitivity corresponding to each of the plurality of combinations for the purpose of producing a biological product that exhibits or will exhibit the phenotypic outcome.

According to various implementations of the invention, a method for selecting candidate components that impact a biological process may include, for each candidate component, where each candidate component affects, directly or indirectly, a phenotypic outcome of the biological process, where the phenotypic outcome is predicted by a computer model of the biological process, determining an optimal characteristic for each candidate component based on whether the computer model predicts a global or local optimum for the phenotypic outcome using the optimal characteristic. The method may include, for each candidate component, determining a sensitivity around the optimal characteristic using the computer model. The method may further include selecting a candidate component based on the phenotypic outcome and the determined sensitivity for the purpose of producing a biological product that exhibits or will exhibit the phenotypic outcome.

### BRIEF DESCRIPTION OF THE DRAWINGS

FIG. 1 is a block diagram illustrating an example of a system configured to select single or combinations of candidate components that enhance a biological process, according to various implementations of the invention.

FIG. 2 is a flow diagram illustrating an example of a process that selects candidate combinations of components that enhance a biological process, according to various implementations of the invention.

FIG. 3 is a data flow diagram illustrating an example of a process that determines optimal characteristics, according to various implementations of the invention.

FIG. 4 is a data flow diagram illustrating an example of a process that performs sensitivity analysis of optimal characteristics, according to various implementations of the invention.

FIG. 5 is a flow diagram illustrating an example of a process that selects single candidate components that enhance a biological process, according to various implementations of the invention.

### DETAILED DESCRIPTION OF THE INVENTION

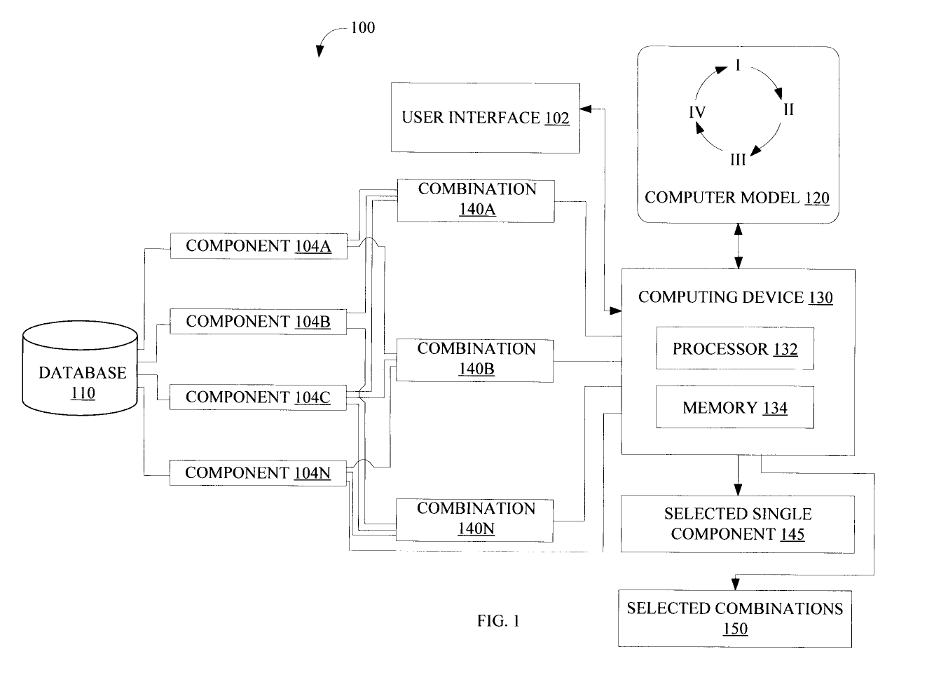

FIG. 1 is a block diagram illustrating a system 100 configured to select single or combinations of candidate biological components that affect a biological process, according to various implementations of the invention. According to various implementations of the invention, system 100 may include, among other things, a user interface 102, a database 110, a computer model 120, and a computing device 130. In some implementations, computing device 130 selects from among various candidate combinations 140 (illustrated in FIG. 1 as combinations 140A, 140B, . . . , 140N; hereinafter “combination 140”) such as gene combinations of biological components 104 (illustrated in FIG. 1 as components 104A, 104B, 104C, . . . , 104N; hereinafter “component 104”) such as genes that affect the biological process. In some implementations of the invention, computing device 130 may include, among other things, a processor 132 and a memory 134. In some implementations, processor 132 includes one or more processors configured to perform various functions of computing device 130. In some implementations of the invention, memory 134 includes one or more tangible (i.e., non-transitory) computer readable media. Memory 134 may include one or more instructions that when executed by processor 132 configure processor 132 to perform the functions of computing device 130.

In some implementations, computing device 130 may determine optimal characteristics of components 104 that result in a desirable phenotypic outcome of the biological process as predicted by computer model 120. In some implementations, computer model 120 may include various mathematical functions, calculations, and/or other instructions configured to predict phenotypic outcomes or otherwise simulate a biological process. In some implementations, computing device 130 may perform sensitivity analysis around the optimal characteristics. The sensitivity analysis may be used to determine whether the candidate combinations 140 are robust over a range across the optimal characteristics. In some implementations, computing device 130 may select from among various candidate combinations 140 based on the sensitivity analysis and the phenotypic outcome. The one or more selected combinations (illustrated in FIG. 1 as selected combinations 150) may be used in a biological product that exhibits or will exhibit the predicted phenotypic outcome. In these implementations, combinations of components may be selected that are predicted to cause a desirable phenotypic outcome.

In some implementations, computing device 130 may determine optimal characteristics of a single component 104 that result in a desirable phenotypic outcome of the biological process as predicted by computer model 120. In some implementations, computing device 130 may perform sensitivity analysis around the optimal characteristics. The sensitivity analysis may be used to determine whether the single component 104 is robust over a range across the optimal characteristics. In some implementations, computing device 130 may select from among various candidate components 104 based on the sensitivity analysis and the phenotypic outcome. The selected component (illustrated in FIG. 1 as selected single component 145) may be used in a biological product that exhibits or will exhibit the predicted phenotypic outcome. In these implementations, a single component 104 may be selected that is predicted to cause a desirable phenotypic outcome.

Thus, according to various implementations of the invention, computing device 130 may be configured to perform various functions described herein to select single components 104 and/or combinations 140 of components 104 as would be appreciated using the disclosure herein.

The biological process may include, but is not limited to, a process such as photosynthesis and/or other process that is regulated by or is otherwise affected by component 104 and/or combination 140 of biological components 104. Thus, in some implementations, instead of analyzing an individual component 104 and its impact on the biological process, different combinations 140 may be analyzed and/or optimized to determine their effect on the biological process. In some implementations, an individual component 104 and its impact on the biological process may be analyzed.

In some implementations, components 104 and/or their association with the biological process may be stored in database 110. In other words, database 110 may store, among other things, various components 104 believed to be or determined to impact or otherwise affect the biological process.

In some implementations, component 104 may include, but is not limited to: a nucleic acid sequence such as a sequence that encodes a gene, mRNA, or other sequence; a gene product such as a protein; and/or other biological/chemical substance that in combination with other components 104 affect the biological process. In some implementations, a candidate combination 140 includes a combination of genes. In these implementations, component 104 includes genes that when combined with other genes in the gene combination together affect the biological process. In some implementations, a candidate combination 140 includes a number of proteins such as enzymes that together regulate, participate in, or otherwise affect the biological process. Thus, particular combinations 140 may be selected to achieve a desired effect on the biological process.

In some implementations of the invention, each of the components 104 may affect, directly or indirectly, a phenotypic outcome of the biological process. The phenotypic outcome may include a result of the biological process that may be measured, predicted, or otherwise observed. For example, the phenotypic outcome may include photo-assimilation of carbon dioxide in the biological process of photosynthesis.

In some implementations, component 104 may directly affect a phenotypic outcome by participating in one or more processes such as biochemical reactions that impact the phenotypic outcome. For example, component 104 may include a gene encoding an enzyme that catalyzes a biochemical reaction or otherwise participates in the biological process.

In some implementations, component 104 may indirectly affect a phenotypic outcome by influencing another biological component that impacts the phenotypic outcome. For example, component 104 may regulate such as inhibit or promote another component but not directly participate in one or more processes that impact the phenotypic outcome.

In some implementations, computer model 120 may simulate the biological process. In some implementations, computer model 120 may predict a phenotypic outcome of the biological process. Accordingly, various components 104 and/or combinations 140 that improve photo-assimilation of carbon dioxide during photosynthesis, for example, may be analyzed using computing device 130. In implementations where components 104 include genes, computer model 120 may provide a linkage between a genotype and its phenotype by predicting a phenotypic outcome based on the genotype. As would be appreciated, the foregoing are non-limiting examples only; other biological processes and phenotypic outcomes may be modeled and/or predicted.

In some implementations, each of components 104 may be associated with various characteristics such as, for example, an expression level (such as a level of expression of a gene), a quantity (such as an amount or concentration), kinetic properties (such as a catalysis rate), binding properties (such as a binding rate), stability (such as a degradation rate), phosphorylation state (such as a rate of phosphorylation or dephosphorylation), other state of activity based on chemical modification of a gene or protein, a methylation state, or an acetylation state, and/or other characteristics of component 104 that may affect the biological process.

In some implementations, characteristics of components 104 may include whether to include a component 104 in computer model 120. For example, computer device 130 may be used to simulate a “knock-out” of a gene to determine whether the knocked-out gene is predicted to cause a desirable phenotypic outcome. In some implementations, computer model 120 may remove a variable that represents the knocked-out gene from computer model 120. In some implementations, computer model 120 may set an expression level or other characteristic to zero (or substantially zero) to achieve this effect. In this manner, the characteristic of being knocked-out or otherwise eliminated from the simulation may facilitate predicting effects of knock-outs on the phenotypic outcome.

In some implementations, variations of each of the characteristics of a component 104 may have different effects on the biological process. For example, different quantities of a particular enzyme among a combination of other enzymes may have different effects on the biological process. Thus, characteristics of components 104 may be optimized so that a desirable effect on the biological process is predicted by computer model 120. In some implementations, computer model 120 may be used to predict such effects.

In this manner, the effect of the combination 140, components 104, characteristics of components, and/or input parameters may be predicted to determine their effect, either alone or in combination, on the biological process so that a desired effect may be achieved. In some implementations, the desired effect may be measured as a predetermined quantity and/or a comparison to a baseline level of the phenotypic outcome. For example, the desired effect on the biological process may be measured against a particular level of carbon dioxide assimilation predicted by model 120. In another example, the desired effect may be a particular percentage increase in the level of carbon dioxide assimilation predicted by model 120 compared to a baseline level of carbon dioxide assimilation.

In some implementations of the invention, computer model 120 may take as input, among other things, a single candidate component to be modified and/or combination 140 to be modified and may simulate a biological process based on the single candidate component and/or combination 140. For example, computer model 120 may simulate photosynthesis based on effects of modifications to a single candidate component that may be involved in photosynthesis and/or effects of modifications to various combinations 140 that each include components 104 that may be involved in photosynthesis.

In some implementations of the invention, computer model 120 may be configured to receive various inputs associated with combinations 140 and/or components 104. In some implementations of the invention, at least a portion of the inputs may be received via user interface 102. Thus, users of system 100 may specify via user interface 102 one or more combinations 140 to be tested by indicating one or more components 104, various characteristics associated with components 104, and/or other input parameters to be included in the simulation. In this manner, via system 100 a user may initialize or otherwise setup an experiment that runs in silico such that computing device 130 may select combinations 140 and/or characteristics that are predicted to cause a desirable effect on the biological process.

In some implementations, computing device 130 may determine an optimal characteristic for each of components 104 based on whether the computer model 120 predicts a global or local optimum for the phenotypic outcome using the optimal characteristic so that a desired effect on the biological process may be achieved. An “optimal characteristic” may include a particular variant, or range of variants that includes a window around the optimal characteristic, predicted to cause a certain phenotypic outcome that is more desirable than other phenotypic outcomes associated with sub-optimal characteristics. In other words, the optimal characteristic (such as a particular gene expression level or other characteristic) may include a characteristic that is predicted to cause a desired phenotypic outcome more so than a non-optimal characteristic.

In some implementations, the desired phenotypic outcome may include a global or a local optimum. In other words, various characteristics may cause computer model 120 to predict various phenotypic outcomes, some of which may be local optima (i.e., phenotypic outcomes that are greater—or less—than neighboring outcomes) or global optima (i.e., phenotypic outcomes that are greater—or less—than substantially all other outcomes). In some implementations, local or global phenotypic outcomes represent phenotypic outcomes that are desirable. Thus, when optimizing characteristics, characteristics may be determined optimal depending on whether they cause computer model 120 to predict global or local optimum phenotypic outcomes. In these implementations, characteristics may be determined to be optimal when computer model 120 predicts global or local optimum phenotypic outcomes.

In some implementations, an optimal characteristic may include a level or range of levels of gene expression (that results in expression of a protein, for example) that is predicted to cause a phenotypic outcome that is more desirable than a phenotypic outcome associated with a sub-optimum level of expression. For example, an optimal expression level of a gene may include an over-expression that is 150% (hereinafter 1.5× for convenience) of an expression level of the gene that normally occurs or otherwise is predicted to naturally occur in a plant.

In some implementations, a window around and including the optimal characteristic may be used. For example, a window may include the optimal level of over-expression of 1.5× as well as a range around the optimal level such as 1.2×-1.5×, 1.2×-1.6×, 1.5×-1.7×, and so forth. As would be appreciated, in this example, an optimal expression level may be higher than a sub-optimal expression level and vice versa. Because computer model 120 may predict a phenotypic outcome based on, for example, the gene and its expression level, different expression levels may be simulated to predict their effect on the phenotypic outcome. In this manner, computing device 130 may determine an optimal characteristic or range of characteristics for each of components 104 that cause a desirable phenotypic outcome.

In some implementations, the desirable phenotypic outcome may include an increase of the phenotypic outcome above a predefined level compared to a baseline outcome. As would be appreciated, the desirable phenotypic outcome may include a decrease of the phenotypic outcome below a predefined level compared to a baseline outcome. In some implementations, the baseline outcome may include a phenotypic outcome predicted by model 120 when, for example, genes of a gene combination are expressed at normal expression levels so that the effect of over-expression and/or under-expression of genes of the gene combination may be determined and compared against the normal expression levels.

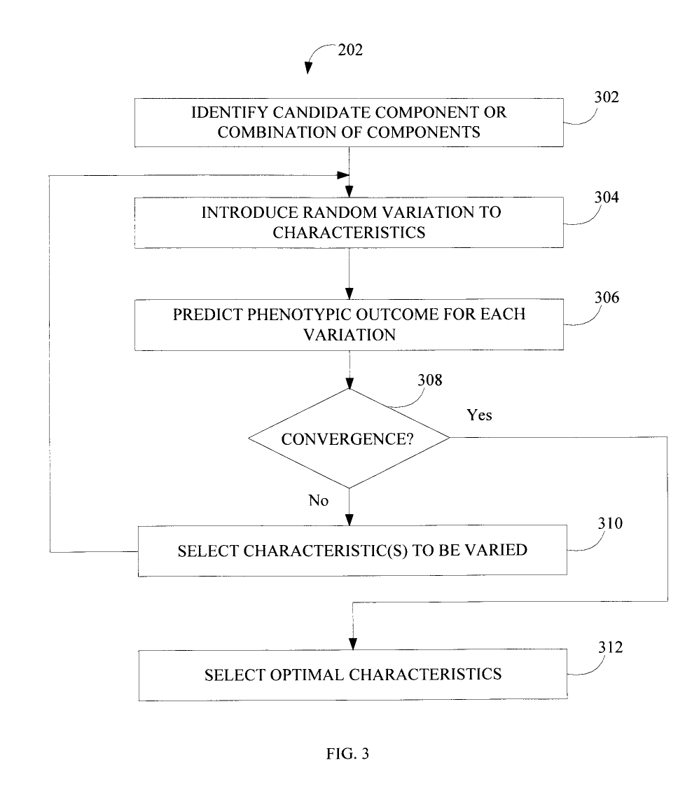

In some implementations of the invention, computing device 130 may perform an optimization process that determines an optimal characteristic for a single candidate component and/or each of components 104 of combination 140. In some implementations, the optimization process, which is described further with respect to FIG. 3, may use an evolutionary algorithm. In other words, in some implementations, computing device 130 may perform an optimization process (such as the process illustrated in FIG. 3) that determines an optimal characteristic for a single candidate component. In some implementations, computing device 130 may perform an optimization process (such as the process illustrated in FIG. 3) that determines an optimal characteristic for each of components 104 of combination 140. In some implementations, whether on single candidate components and/or combination 140, the evolutionary algorithm may be used to reduce computational burdens on computing device 130. However, as would be appreciated, other optimization processes may be used. For example, optimization processes may include, but is not limited to, a gradient-based routine, a direct search algorithm, a genetic algorithm, a particle swarm algorithm, simulated annealing, and/or other optimization routines.

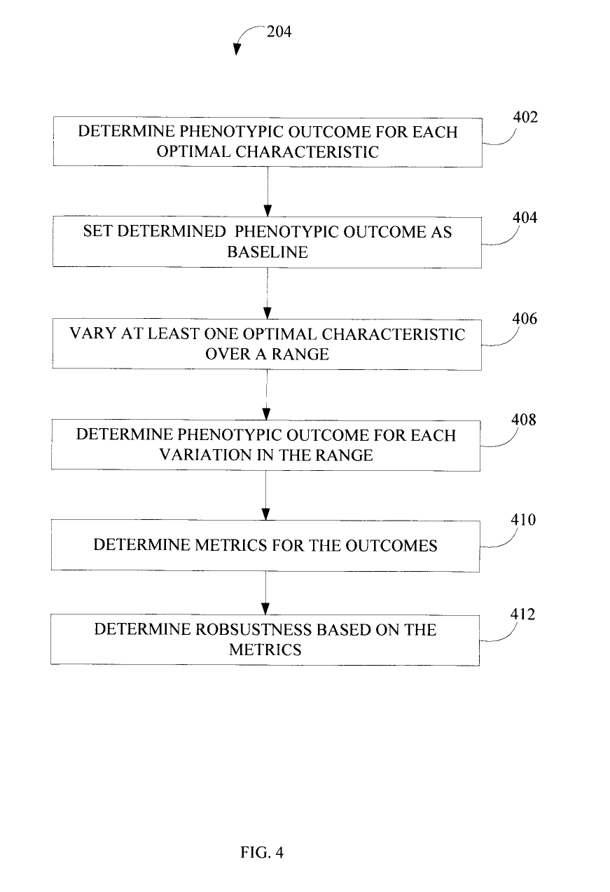

In some implementations, computing device 130 may, for a single candidate component and/or each of combinations 140, determine a sensitivity of the biological process around the optimal characteristics associated with each of the corresponding components 104 using computer model 120. In some implementations of the invention, computing device 130 may determine a sensitivity by performing a sensitivity analysis. In some implementations, results of the sensitivity analysis may be used to select single candidate components and/or combinations 140 that have a robust response across a range of characteristics around the optimal characteristics. In other words, a single candidate component or a combination 140 that does not exhibit a desired phenotypic outcome across a range around the optimal characteristics of corresponding components 104 may be filtered out using results of the sensitivity analysis, which is described further with respect to FIG. 4. Thus, in some implementations, computing device 130 may perform sensitivity analysis (such as the sensitivity analysis illustrated in FIG. 4) when selecting a single candidate component. In some implementations, computing device 130 may perform sensitivity analysis (such as the sensitivity analysis illustrated in FIG. 4) when selecting a combination 140.

In some implementations, computing device 130 may select a single candidate component or one or more of combinations 140 based on the phenotypic outcome and the determined sensitivity corresponding to each of combinations 140 for the purpose of producing a biological product that exhibits or will exhibit the phenotypic outcome. The biological product may include an organism, a progenitor such as a seed, a biological construct such as a cell or nucleic acid sequence, and/or other biological product in which selected candidate components or combinations 140 may be used to cause the phenotypic outcome. In some implementations, the biological product may be generated according to conventional techniques such as, but not limited to, genetically modifying or otherwise engineering an existing organism, breeding, selecting alleles, and/or using other conventional techniques capable of producing the biological product.

In some implementations, the selected single candidate component or combinations 140 have a robust response across a range of optimal characteristics. The robust response may be desirable because it may be difficult to generate a biological product that exhibits or otherwise includes the precise optimal characteristics. By selecting single candidate components and/or combinations 140 that have a robust response across the range of optimal characteristics, the biological product may exhibit the desired phenotypic outcome despite failing to have included or otherwise expressed the optimal characteristics.

For example, a desirable phenotypic outcome may be predicted for a combination 140 such as a gene combination that includes components 104 such as genes. The desirable phenotypic outcome may be predicted based on an optimal expression level of each of the genes of the gene combination. However, when a biological product having the gene combination is produced, actual expression levels may be different from the optimal expression levels as predicted. If the gene combination is not robust across optimal expression levels, then the predicted phenotypic outcome may not be observed in the biological product. The same may apply for single gene candidates as would be appreciated based on the disclosure herein.

In some implementations, a sensitivity of a single candidate component or combination 140 may be determined to ascertain its robustness across a range of optimal characteristics of corresponding components 104. In the above example, the sensitivity of the gene combination may be determined by simulating a range of expression levels around each of the optimal expression levels for the genes and predicting the corresponding phenotypic outcomes. If the predicted phenotypic outcomes for the range of expression levels around each of the optimal expression levels are within a predefined difference of the phenotypic outcome associated with the optimal levels of expression, then the combination 140 may be deemed robust. On the other hand, when the phenotypic outcomes predicted for the range of expression levels around each of the optimal expression levels falls outside the predefined difference, the combination 140 may be deemed not robust and accordingly filtered out. As would be appreciated, these differences may be measured via a mean, a standard deviation, and/or other statistical metric associated with the predicted phenotypic outcome.

In some implementations, by performing sensitivity analysis, computing device 130 may select single candidate components based on whether it is robust across a range of optimal characteristics so that the selected candidate component has a greater chance of exhibiting the predicted phenotypic outcome around a range of optimal characteristics. In some implementations, by performing sensitivity analysis, computing device 130 may select combinations 140 based on whether they are robust across a range of optimal characteristics so that selected combinations 140 have a greater chance of exhibiting the predicted phenotypic outcome around a range of optimal characteristics. In some implementations, computing device 130 may determine a second optimal characteristic for each of the plurality of components based on the determined sensitivity. For example, while determining whether a particular characteristic is robust across a range, computing device 130 may determine a different optimal characteristic from among the range. In some implementations, the determined second optimal characteristic may cause a more desirable phenotypic outcome than the optimal characteristic as predicted by computer model 120.

In some implementations, computing device 130 may determine selection criteria, which may be used to select various single candidate components that may impact the biological process. In some implementations, computing device 130 may determine selection criteria, which may be used to select various candidate combinations 140 that may impact the biological process. In some implementations, computing device 130 may determine the selection criteria by directly ascertaining or otherwise by receiving, such as from a user operating user interface 102, the selection criteria.

In some implementations of the invention, the selection criteria may include a frequency that a component 104 occurs in candidate combinations 140 (in implementations where combinations 140 are selected), an indication of a level of difficulty of experimental implementation, an indication that component 104 should or should not be used, and/or other criteria that may be used to further select single candidate components or candidate combinations 140.

In some implementations where combinations 140 are selected, the frequency may indicate whether the component 104 is an important factor of the impact on the biological process. For example, a gene frequently appearing in different gene combinations predicted to impact a phenotypic outcome may be an important gene. In another example, a particular enzyme appearing in different combinations of enzymes predicted to impact the phenotypic outcome may significantly impact the phenotypic outcome. Thus, in some implementations, computing device 130 may select candidate combinations based on the frequency so that selected combinations 140 include one or more components 104 having a particular frequency in which component 104 is a member of various combinations 140.

In some implementations, computing device 130 may use the indication of a level of difficulty of experimental implementation to filter out component 104. In some implementations where combinations 140 are selected, computing device 130 may filter out candidate combinations 140 that include component 104. For example, computing device 130 may filter out component 104 upon receiving an indication that component 104 such as a gene is difficult to manipulate. In another example, computing device 130 may filter out component 104 upon determining an indication that component 104 such as a protein is difficult to purify or otherwise experimentally implement in a laboratory. In another example, computing device 130 may filter out or include component 104 based on positive or negative indications of component 104. For example, upon determining that component 104 should not be used because it is associated with proprietary rights, computing device 130 may filter out component 104. On the other hand, upon determining that component 104 is freely available for use, computing device 130 may include component 104. As would be appreciated, these and other indications/selection criteria may be stored in database 110 and/or be input through user interface 102.

In operation, computing device 130 may select various single candidate genes or various gene combinations based on their predicted impact on a phenotypic outcome of the biological process. In some implementations, computing device 130 may make this determination based on input from a user. For example, the user may wish to determine whether particular genes or gene combinations may improve the phenotypic outcome. In some implementations, computing device 130 may make this determination based on information related to the biological process. For example, database 110 may include various components 104 believed to be or determined to be involved in the biological process.

In some implementations, computing device 130 may determine optimal over-expression levels of a candidate gene or each of the genes of the gene combination. As would be appreciated, optimal under-expression levels (including zero expression) of the candidate gene or each of the genes of the gene combination may also be determined as appropriate. In this manner, optimal expression levels of the genes that are predicted to cause a desirable phenotypic outcome may be determined.

In some implementations, computing device 130 may perform sensitivity analysis around the optimal expression levels for the candidate gene. In some implementations, computing device 130 may perform sensitivity analysis around the optimal expression levels for the gene combination. The sensitivity analysis may be used to determine whether the candidate genes or gene combinations are robust across a range of the optimal expression levels. In some implementations, computing device 130 may select various candidate genes or gene combinations based on the sensitivity analysis and the phenotypic outcome. In this manner, the robustness of the candidate genes or gene combinations may be determined so that even when the optimal expression levels are not achieved, the predicted phenotypic outcome may still be exhibited. As would be appreciated, the foregoing operation is a non-limiting example for illustration purposes only. Other combinations 140, components 104, and/or characteristics may be used to determine their impact on other phenotypic outcomes of biological processes.

As would be appreciated, although illustrated in FIG. 1 as distinct from one another, various portions of system 100 and their associated functions may be included with other portions. For example, user interface 102, database 110, and/or computer model 120 may be distinct from or be included within a memory of computing device 130.

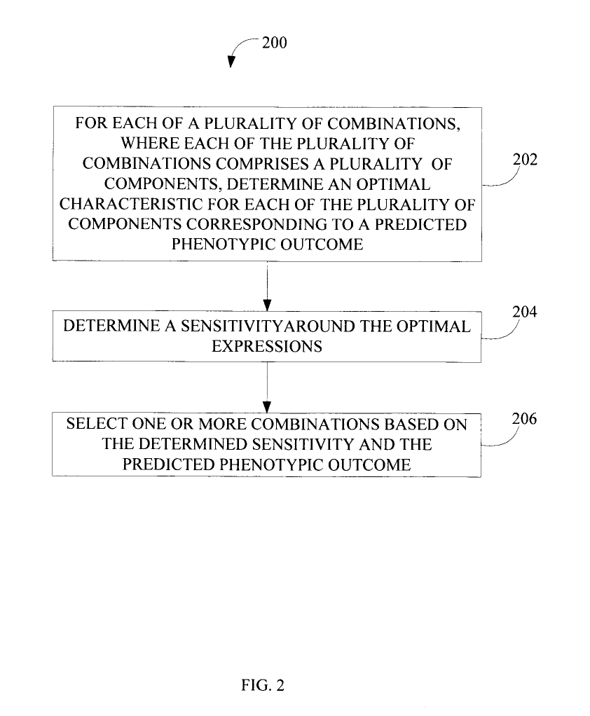

FIG. 2 is a data flow diagram illustrating a process 200 that selects candidate combinations of components that affect a biological process, according to various implementations of the invention. The various processing operations and/or data flows depicted in FIG. 2 (and in the other drawing figures) are described in greater detail herein. The described operations for a flow diagram may be accomplished using some or all of the system components described in detail above and, in some implementations of the invention, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting. Furthermore, the various processing operations and/or data flows depicted in FIG. 2 (and in the other drawing figures) may be applied when selecting single candidate components and/or combinations 140 as would be appreciated based on the disclosure herein. In other words, in some implementations, the various processing operations and/or data flows depicted in FIG. 2 (and in the other drawing figures) may be used when selecting single candidate components. In some implementations, the various processing operations and/or data flows depicted in FIG. 2 (and in the other drawing figures) may be used when selecting combinations 140.

In some implementations, process 200 may select candidate combinations of components that affect a biological process. In some implementations, each of the plurality of combinations includes a plurality of components. Each of the plurality of components may directly or indirectly affect a phenotypic outcome, which is predicted by a computer model that models the biological process.

In an operation 202, process 200 may determine an optimal characteristic for each of the plurality of components based on whether the computer model predicts a global or local optimum for the phenotypic outcome using the optimal characteristic. For example, an optimum expression level of each gene (observed as a quantity of enzyme, for example) of a gene combination may be determined based on its effect on carbon dioxide assimilation as predicted by a model that simulates photosynthesis. In this manner, a candidate gene combination, for example, may include a combination of genes and associated optimal expression levels corresponding to a desired phenotypic outcome. An expression level may be deemed optimal when a level of carbon dioxide assimilation predicted by the computer model is at a global or a local optimum.

In an operation 204, process 200 may, for each of the plurality of combinations, determine a sensitivity of the biological process for each of the plurality of combinations around the optimal characteristics associated with each of the corresponding plurality of genes using the computer model. For example, a sensitivity analysis of each of the candidate gene combinations may be used to determine whether the candidate gene combinations are sensitive to variations in the optimal expression levels of each of the corresponding genes.

In an operation 206, process 200 may select one or more of the plurality of combinations based on the phenotypic outcome and the determined sensitivity corresponding to each of the plurality of combinations for the purpose of producing a biological product that exhibits or will exhibit the phenotypic outcome. For example, a candidate gene combination may be selected based on a phenotypic outcome in which the gene combination is predicted to cause and based on the determined sensitivity. In this manner, candidate gene combinations that are relatively insensitive to variations to the optimal expression levels may cause the predicted phenotypic outcome or a phenotypic outcome that is acceptably close (based on a predefined difference) to the predicted phenotypic outcome even when the optimal expression levels are not achieved in the biological product during, for example, laboratory experimentation and/or manufacturing.

FIG. 3 is a data flow diagram illustrating an example of a process 202 that determines optimal characteristics, according to various implementations of the invention. In some implementations, process 202 uses an evolutionary algorithm to determine the optimal characteristics. The evolutionary algorithm described herein may simulate iterations by randomly adjusting (i.e., introducing a variation to) one or more characteristics of a component or combination of components in a population and predicting the effects of the adjustments on the phenotypic outcome as predicted by a model such as computer model 120. The component or combination 140 of components having the greatest success (i.e., yielding the most desirable phenotypic outcomes) based on predictions by the model may be selected for the next iteration or generation of components or combinations of components and the process is repeated until convergence is met.

In an operation 302, process 202 may identify or otherwise receive candidate components or combinations 140. In some implementations, all components or combinations of components 104 may be selected. In these implementations, the number of components 104 may be sufficiently small so that all combinations of components 104 may be processed.

In some implementations, a sampling of all combinations of components 104 may be selected. In these implementations, the number of components 104 may be sufficiently high so that processing all combinations of components 104 may be computationally prohibitive. In some implementations, combinations 140 may be sampled based on weighting previously analyzed combinations 140. For example, weights may be determined using regression analysis, where a regressor may include variables that describe previously analyzed combinations 140 and a regress and may include predicted characteristics such as the phenotypic outcome for these combinations 140. In some implementations, combinations 140 may be described by 0-1 (“dummy”) variables indicating the presence or absence of each component 104 such as a gene in combination 140. In some implementations, the regressor may include interaction terms indicating the presence or absence of pairs of components 104 in the combination 140. In some implementations, the regression analysis may include measured trait levels or other characteristics determined based on prior laboratory investigations of specific combinations 140, predictions derived from other in silico methods, and/or other scientific hypotheses. In some implementations, according to the outcome of the regression analysis, at least some of components 104 of the combination 140 may be weighted higher than other components 104 not associated with a desirable phenotypic outcome. As would be appreciated, however, given sufficient computational resources and/or time, any number of combinations 140 may be processed.

In an operation 304, process 202 may introduce a random variation to characteristics of a single candidate component (as illustrated in Table 1, for example) or components 104 within combination 140 (as illustrated in Table 2, for example). For example, process 202 may indicate an expression level of an enzyme to be 1.2× of a baseline level of expression of the enzyme in an iteration. In some implementations related to combinations 140, a characteristic for at least one component 104 of combination 140 may be varied. In some implementations related to combinations 140, a characteristic for each component 104 of combination 140 may be varied. In an operation 306, process 202 may predict (or cause to be predicted by computer model 120, for example) the phenotypic outcome of the variation. In the above example, process 202 may predict the phenotypic outcome of the enzyme having an expression level that is 1.2× of the baseline level.

In some implementations, a random variation to a characteristic of a single candidate component or components 104 within combination 140 may be constrained to a particular value or range of values. In some implementations, an expression level of a gene may be constrained to an allowable expression range. In these implementations, in operation 304, process 202 may vary an optimal expression level within the allowable expression range. In some implementations, a user may input such constraints using an interface such as user interface 102. For example, a user may input an allowable expression range so that the optimal expression range is not varied beyond the allowable expression range.

In an operation 308, process 202 determines whether convergence is met. In some implementations, convergence is met when the predicted phenotypic outcome substantially remains the same from one iteration to the next iteration within a particular tolerance for the number of iterations. In some implementations, the iterations automatically terminate when enough (a particular number) of iterations have been performed.

In operation 308, if convergence is not met, then processing may proceed to an operation 310, where one or more characteristics to be varied are selected. For example, conceptually speaking, the most fit generation is selected in order to introduce a variation to the most fit generation. In some implementations, a set of characteristics that are predicted to cause the greatest phenotypic outcome may be selected in operation 310. Upon selection, processing may return to operation 304, where a variation is introduced to the selected characteristic(s). For example, a random variation in a characteristic having a 1.3× expression level may cause the greatest phenotypic outcome compared to other tested expression levels. In this example, the random variation having the 1.3× expression level may be selected in operation 310 so that a random variation is introduced to the 1.3× expression level in operation 304.

Returning to operation 308, if convergence is met, then processing may proceed to an operation 312, where an iteration having an impact on the phenotypic outcome may be selected as the optimal characteristic. In some implementations, the last iteration having an impact on the phenotypic outcome may be selected. In some implementations, the last iteration having the greatest impact on the phenotypic outcome may be selected.

For example, referring to Tables 1 and 2, the phenotypic outcome P is expressed as a number where higher P values indicate more desirable phenotypic outcomes. Table 1 illustrates randomly varying a characteristic of a single candidate component. Table 2 illustrates randomly varying characteristics of combinations of components 1, 2, and N. P values are used for illustrative purposes only. In some implementations, lower P values could be more desirable. In some implementations, the P value may represent any measurable phenotypic outcome. According to Table 1, random variations to characteristics may be introduced from one iteration (I1, I2, . . . , IN) to the next iteration with their corresponding phenotypic outcome P as predicted by a computer model such as computer model 120.

In some implementations, iteration I4 of Table 1 may be selected as the optimal over-expression level corresponding to 1.3× over-expression. In some implementations, iteration I4 of Table 2 may be selected as the optimal over-expression levels for 1.1× over-expression for component 1, 1.0× expression for component 2, 0.8× expression for component N. As would be appreciated, the values illustrated in Tables 1 and 2 are illustrative only. Furthermore, in implementations optimizing combinations of components, characteristics of each component may be randomly varied separately in an iteration as illustrated in Table 2 or may be randomly varied together in an iteration so that the characteristics of each component are varied in the same manner as one another (not illustrated in Table 2).

TABLE 1

| Iteration | Random variation, single candidate component | P |
|---|---|---|
| I1 | 1.0x | 1 |
| I2 | 0.9x | 1.2 |
| I3 | 1.2x | 1.2 |
| I4 | 1.3x | 1.5 |
| IN | 1.4x | 1.5 |

TABLE 2

| | Random | Random | Random | |
|---|---|---|---|---|
| | variation, | variation, | variation, | |
| Iteration | component 1 | component 2 | component N | P |
| I1 | 0.7x | 0.8x | 0.6x | 1 |
| I2 | 1.3x | 1.2x | 1.4x | 1.1 |
| I3 | 1.0x | 1.4x | 0.7x | 1.2 |
| I4 | 1.1x | 1.0x | 0.8x | 1.4 |
| IN | 0.9x | 0.7x | 1.1x | 1.4 |

In some implementations, process 202 may be repeated for all components or combinations of components that increased (i.e., had a desirable impact on) the phenotypic outcome. The evolutionary process described with respect to process 202 may not produce global optimal characteristics because the parameter space is typically too large to survey comprehensively, and because random variations to characteristics are introduced. As such, process 202 may produce different results each time it is run. By repeating process 202 a number of times, a range of optimal characteristics may be achieved, thereby approaching a more global optimum. Accordingly, characteristics having a greatest impact on the phenotypic outcome using the global optimum may be selected as the optimal characteristics. For instance, for each rerun of process 202, characteristics of each component 104 of each combination 140, their predicted impact on the phenotypic outcome, mean, standard deviation, maximal response, minimum response, and/or other metrics may be compared with one another. In some implementations, the optimal characteristics and/or candidate combinations 140 may be determined based on the comparisons.

As would be appreciated, the optimal characteristic may be determined for a particular component 104 among a plurality of components 104 in combination 140. Thus, characteristics (such as expression levels) of each component 104 may be optimized individually or together with other components 104 within combination 140 by introducing variations in more than one component 104 of a combination 140 in an iteration.

FIG. 4 is a data flow diagram illustrating an example of a process 204 that performs sensitivity analysis of optimal characteristics, according to various implementations of the invention. In some implementations, the sensitivity analysis may be used to determine a robustness of the optimal characteristics across a range so that the impact on the phenotypic outcome is substantially the same or at least similar within a tolerance across the range even when the optimal characteristics are not exhibited. In other words, if the biological product exhibits the characteristics within the range of optimal characteristics as determined by the sensitivity analysis, the predicted phenotype may be achieved in the biological product.

In an operation 402, process 204 may, for a single candidate component or each combination 140, determine the phenotypic outcome associated with the optimal characteristic for each component 104 of a combination 140. In other words, a particular single candidate component or each component 104 of combination 140 is set to simulate its corresponding optimal characteristic so that model 120 predicts the phenotypic outcome of the component or combination 140. For example, for a particular gene candidate, optimal expression levels of the candidate gene may be used to predict a phenotypic outcome. In an example using combinations of genes, for a particular gene combination, optimal expression levels of each of the genes of the gene combination may be used to predict a phenotypic outcome. The optimal expression levels may have been determined based on their predicted impact on the phenotypic outcome in a desirable manner, such as by process 202 illustrated in FIG. 3.

In an operation 404, process 204 may set the determined phenotypic outcome as a baseline phenotypic outcome. The baseline phenotypic outcome may be used as a comparison for the sensitivity analysis.

In an operation 406, at least one optimal characteristic (corresponding to a component 104) may be used as a baseline characteristic and varied over a range around the optimal characteristic. In some implementations, optimal characteristics of other components of combination 140 are unchanged so that the effect of the varied characteristic on the phenotypic outcome may be predicted. In some implementations, the range may be absolute or additive. In some implementations, the range may be relative or multiplicative.

For example, an optimal expression level for the single gene candidate or a gene in a gene combination may be used as a baseline of the characteristic. The optimal expression level may be varied over a range so that the variations may be compared against the baseline of the characteristic. In some implementations using combinations of genes, the optimal expression levels of other genes in the same gene combination may be kept constant so that the phenotypic outcome as a function of the varied optimal expression level for the tested gene may be observed. For instance, an optimal expression level of a gene at 1.2 may be set as a baseline zero and compared to a range ±2 or other range about the new baseline. In this example, the expression level may be varied across this range such that the variations include the range: [−2.0, −1.9, . . . , −0.1, 0.0, 0.1, 0.2, . . . , 2]. As would be appreciated, the foregoing is for illustrative purposes only; different characteristics may be varied over different ranges.

In some implementations, one or more characteristics of a biological component 104 may be constrained such that the optimum must be within the constraints. In some implementations, an expression level of a gene may be constrained to an allowable expression range. In these implementations, when determining an optimal expression level, computing device 130 may vary an optimal expression level within the allowable expression range. In some implementations, a user may input such constraints via user interface 102. For example, a user may input an allowable expression range so that the optimal expression range is not varied beyond the allowable expression range.

In an operation 408, a phenotypic outcome may be predicted (such as by computer model 120) for each of the variations in the range for the tested optimal characteristic. In this manner, the effect of deviation from the optimal characteristic on phenotypic outcome may be determined. Because each single candidate component or each component 104 of a particular combination 140 is tested in this manner, the robustness of the single candidate component or particular combination 140 across a range of optimal characteristics may be determined.

In an operation 410, process 204 may determine robustness metrics for all variations of a combination 140. In some implementations, the robustness metrics may include, but are not limited to, a mean phenotypic outcome for all variations, a standard deviation, a maximum value, a minimum value, a range, and/or other metrics associated with an effect of a variation on the predicted phenotypic outcome.

In an operation 412, process 204 may determine a robustness of optimal characteristics of a combination 140 based on the robustness metrics. In some implementations, process 204 may determine that a combination 140 is robust because it causes a mean increase in desired phenotypic outcome that is above a predetermined amount (or mean decrease in an unwanted phenotypic outcome that is below a predetermined amount). In some implementations, process 204 may determine that a combination 140 is robust across a range of characteristics such as expression levels when the standard deviation of variations in phenotypic outcome tested during the sensitivity analysis is below a predetermined value, which may suggest the phenotypic outcome is stable across a range around the optimal characteristics. As would be appreciated, in some implementations, both the mean and standard deviation (and/or other robustness metrics) may be used to determine whether combination 140 is robust.

In some implementations, process 204 described in FIG. 4 may be used to rank (by, for example, computing device 130) various single candidate components based on their mean phenotypic outcomes so that a single candidate component associated with better (i.e., more desirable) phenotypic outcomes rank higher than other single candidate components associated with worse (i.e., less desirable) phenotypic outcomes.

In some implementations, process 204 described in FIG. 4 may be used to rank (by, for example, computing device 130) various combinations 140 based on their mean phenotypic outcomes so that combinations 140 associated with better (i.e., more desirable) phenotypic outcomes rank higher than others associated with worse (i.e., less desirable) phenotypic outcomes.

In some implementations, process 204 described in FIG. 4 may be used to filter out single candidate components that have robustness scores such as standard deviations of phenotypic outcomes that are higher than a particular cutoff value. In other words, process 204 may be used to filter out single candidate components that are sensitive to changes to optimal characteristics associated with the single candidate component.

In some implementations, process 204 described in FIG. 4 may be used to filter out combinations 140 that have robustness scores such as standard deviations of phenotypic outcomes that are higher than a particular cutoff value. In other words, process 204 may be used to filter out combinations 140 that are sensitive to changes to optimal characteristics associated with components 104. In some implementations, process 204 described in FIG. 4 may be used to determine a second optimal characteristic for each of the plurality of components based on the determined sensitivity. In some implementations, the determined second optimal characteristic may cause a more desirable phenotypic outcome than the optimal characteristic as predicted during a process 202.

In some implementations, process 202, process 204, and/or other parameters may be used to select single candidate components. In some implementations, process 202, process 204, and/or other parameters may be used to select candidate combinations 140.

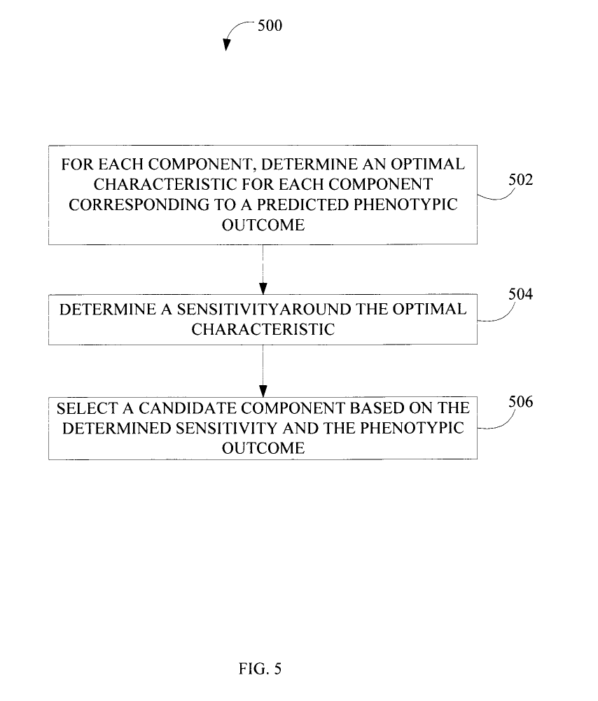

FIG. 5 is a flow diagram illustrating an example of a process 500 that selects single candidate components that enhance a biological process, according to various implementations of the invention. A computer model may predict that a candidate component (illustrated in FIG. 1, for example, as component 104) has an effect on a phenotypic outcome of a biological process. In an operation 502, process 500 may determine an optimal characteristic for a candidate component based on whether the computer model predicts a global or local optimum for the phenotypic outcome using the optimal characteristic. For example, an optimum expression level of a candidate gene (observed as a quantity of enzyme, for example) may be determined based on the effect of an expression level on carbon dioxide assimilation as predicted by a computer model that simulates photosynthesis. The expression level may be deemed optimal when a level of carbon dioxide assimilation predicted by the computer model is at a global or a local optimum compared to other expression levels and/or other genes.

In an operation 504, process 500 may, for each candidate component, determine a sensitivity of the biological process for each of the candidate components around the optimal characteristic using the computer model. For example, a sensitivity analysis of each candidate gene may be used to determine whether the candidate gene is sensitive to variations in the optimal expression level determined in process 502.

In an operation 506, process 500 may select a candidate component based on the phenotypic outcome and the determined sensitivity for the purpose of producing a biological product that exhibits or will exhibit the phenotypic outcome. For example, a candidate gene may be selected based on a phenotypic outcome in which the gene is predicted to cause and based on the determined sensitivity. In this manner, a single candidate gene that is relatively insensitive to variations to the optimal expression level may cause the predicted phenotypic outcome or a phenotypic outcome that is acceptably close (based on a predefined difference) to the predicted phenotypic outcome even when the optimal expression levels are not achieved in the biological product during, for example, laboratory experimentation and/or manufacturing.

The foregoing examples described herein are for illustrative purposes only and are not intended to be limiting. Implementations of the invention may be made in hardware, firmware, software, or any suitable combination thereof. Implementations of the invention may also be implemented as instructions stored on a machine readable medium, which may be read and executed by one or more processors. A tangible machine-readable medium may include any tangible, non-transitory, mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Intangible machine-readable transmission media may include intangible forms of propagated signals, such as carrier waves, infrared signals, digital signals, and other intangible transmission media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A computer implemented method for selecting candidate combinations of components that each impact a biological process, the method comprising:
for each of a plurality of combinations, wherein each of the plurality of combinations comprises a plurality of components, each of the plurality of components affecting, directly or indirectly, a phenotypic outcome of the biological process, wherein the phenotypic outcome is predicted by a computer model of the biological process,
determining, by one or more processors of at least one computing device, an optimal characteristic for each of the plurality of components based on whether the computer model predicts a global or local optimum for the phenotypic outcome using the optimal characteristic;
for each of the plurality of combinations, determining, by the at least one computing device, a sensitivity of each of the plurality of combinations around the optimal characteristics associated with each of the corresponding plurality of components using the computer model; and
selecting one or more of the plurality of combinations based on the phenotypic outcome and the determined sensitivity corresponding to each of the plurality of combinations for the purpose of producing a biological product that exhibits or will exhibit the phenotypic outcome.

2. The computer implemented method of claim 1, wherein the plurality of combinations each comprise a combination of genes, the plurality of components each comprise a plurality of genes, and the optimal characteristics comprise an optimal expression level of each of the plurality of genes.

3. The computer implemented method of claim 2, wherein the plurality of genes comprise at least two genes.

4. The computer implemented method of claim 2, wherein the plurality of genes comprise three or four genes.

5. The computer implemented method of claim 1, wherein at least one of the plurality of components comprise an enzyme affecting the biological process.

6. The computer implemented method of claim 1, wherein the optimal characteristic comprises at least one of an expression level, a quantity, a kinetic property, a binding property, a stability, a phosphorylation state, a methylation state, or an acetylation state.

7. The computer implemented method of claim 1, wherein each of the optimal characteristics includes a window around and including the optimal characteristics.

8. The computer implemented method of claim 1, further comprising:
determining, by the at least one computing device, a selection criterion for at least one of the plurality of components, wherein selecting one or more of the plurality of combinations is further based on the determined selection criteria.

9. The computer implemented method of claim 8, wherein the selection criteria comprises one or more of a frequency that at least one of the plurality of components occurs in the plurality of combinations; an indication of a level of difficulty of experimental implementation of the at least one of the plurality of components; or an indication that the at least one of the plurality of components should or should not be used.

10. The computer implemented method of claim 1, further comprising:
determining, by the at least one computing device, a rank for each of the plurality of combinations based on their predicted phenotypic outcomes, wherein selecting one or more of the plurality of combinations is further based on the determined rank.

11. The computer implemented method of claim 1, further comprising:
determining, by the at least one computing device, a robustness score based on the sensitivity analysis, wherein selecting one or more of the plurality of combinations is further based on the robustness score and a predefined cutoff value.

12. The computer implemented method of claim 1, further comprising:
determining, by the at least one computing device, a second optimal characteristic for each of the plurality of components based on the determined sensitivity.

13. A system for selecting candidate combinations of components that each impact a biological process, the system comprising:
a computing device comprising one or more processors configured to:
for each of a plurality of combinations, wherein each of the plurality of combinations comprises a plurality of components, each of the plurality of components affecting, directly or indirectly, a phenotypic outcome of the biological process, wherein the phenotypic outcome is predicted by a computer model of the biological process,
determine an optimal characteristic for each of the plurality of components based on whether the computer model predicts a global or local optimum for the phenotypic outcome using the optimal characteristic;
for each of the plurality of combinations, determine a sensitivity of each of the plurality of combinations around the optimal characteristics associated with each of the corresponding plurality of components using the computer model; and
select one or more of the plurality of combinations based on the phenotypic outcome and the determined sensitivity corresponding to each of the plurality of combinations for the purpose of producing a biological product that exhibits or will exhibit the phenotypic outcome.

14. The system of claim 13, wherein the plurality of combinations each comprise a combination of genes, the plurality of components each comprise a plurality of genes, and the optimal characteristics comprise an optimal expression level of each of the plurality of genes.

15. The system of claim 14, wherein the plurality of genes comprise at least two genes.

16. The system of claim 14, wherein the plurality of genes comprise three or four genes.

17. The system of claim 13, wherein at least one of the plurality of components comprise an enzyme affecting the biological process.

18. The system of claim 13, wherein the optimal characteristic comprises at least one of an expression level, a quantity, a kinetic property, a binding property, a stability, a phosphorylation state, a methylation state, or an acetylation state.

19. The system of claim 13, wherein each of the optimal characteristics include a window around and including the optimal characteristics.

20. The system of claim 13, the one or more processors further configured to:
determine a selection criterion for at least one of the plurality of components, wherein selecting one or more of the plurality of combinations is further based on the determined selection criteria.

21. The system of claim 20, wherein the selection criteria comprises one or more of a frequency that at least one of the plurality of components occurs in the plurality of combinations; an indication of a level of difficulty of experimental implementation of the at least one of the plurality of components; or an indication that the at least one of the plurality of components should or should not be used.

22. The system of claim 13, the one or more processors further configured to:
determine a rank for each of the plurality of combinations based on their predicted phenotypic outcomes, wherein selection of the one or more of the plurality of combinations is further based on the determined rank.

23. The system of claim 13, the one or more processors further configured to:
determine a robustness score based on the sensitivity analysis, wherein selection of the one or more of the plurality of combinations is further based on the robustness score and a predefined cutoff value.

24. The system of claim 13, the one or more processors further configured to:
determine a second optimal characteristic for each of the plurality of components based on the determined sensitivity.

25. A computer implemented method for selecting candidate components that impact a biological process, the method comprising:
for each candidate component, wherein each candidate component affects, directly or indirectly, a phenotypic outcome of the biological process, wherein the phenotypic outcome is predicted by a computer model of the biological process,
determining, by one or more processors of at least one computing device, an optimal characteristic for each candidate component based on whether the computer model predicts a global or local optimum for the phenotypic outcome using the optimal characteristic;
for each candidate component, determining, by the at least one computing device, a sensitivity around the optimal characteristic using the computer model; and
selecting a candidate component based on the phenotypic outcome and the determined sensitivity for the purpose of producing a biological product that exhibits or will exhibit the phenotypic outcome.

26. The computer implemented method of claim 25, wherein the candidate component comprises a gene and the optimal characteristic comprises an optimal expression level of the gene.

27. The computer implemented method of claim 25, wherein the candidate component comprises an enzyme affecting the biological process.

28. The computer implemented method of claim 25, wherein the optimal characteristic comprises at least one of an expression level, a quantity, a kinetic property, a binding property, a stability, a phosphorylation state, a methylation state, or an acetylation state.

29. The computer implemented method of claim 25, wherein the optimal characteristic includes a window around and including the optimal characteristic.

30. The computer implemented method of claim 25, further comprising:
determining, by the at least one computing device, a selection criterion for the candidate component, wherein selecting the candidate component is further based on the determined selection criteria.

31. The computer implemented method of claim 25, further comprising:
determining, by the at least one computing device, a rank for each of the candidate components based on their predicted phenotypic outcomes, wherein selecting the candidate component is further based on the determined rank.

32. The computer implemented method of claim 25, further comprising:
determining, by the at least one computing device, a robustness score based on the sensitivity analysis, wherein selecting the candidate component is further based on the robustness score and a predefined cutoff value.

33. The computer implemented method of claim 25, further comprising:
determining, by the at least one computing device, a second optimal characteristic for each of the plurality of components based on the determined sensitivity.

34. A system for selecting candidate components that impact a biological process, the system comprising:
a computing device comprising one or more processors configured to:
for each candidate component, wherein each candidate component affects, directly or indirectly, a phenotypic outcome of the biological process, wherein the phenotypic outcome is predicted by a computer model of the biological process,
determine an optimal characteristic for each candidate component based on whether the computer model predicts a global or local optimum for the phenotypic outcome using the optimal characteristic;
for each candidate component, determine a sensitivity around the optimal characteristic using the computer model; and
select a candidate component based on the phenotypic outcome and the determined sensitivity for the purpose of producing a biological product that exhibits or will exhibit the phenotypic outcome.

35. The system of claim 34, wherein the candidate component comprises a gene and the optimal characteristic comprises an optimal expression level of the gene.

36. The system of claim 34, wherein the candidate component comprises an enzyme affecting the biological process.

37. The system of claim 34, wherein the optimal characteristic comprises at least one of an expression level, a quantity, a kinetic property, a binding property, a stability, a phosphorylation state, a methylation state, or an acetylation state.

38. The system of claim 34, wherein the optimal characteristic includes a window around and including the optimal characteristic.

39. The system of claim 34, the one or more processors further configured to:
determine a selection criterion for the candidate component, wherein selecting one or more of the candidate component is further based on the determined selection criteria.

40. The system of claim 34, the one or more processors further configured to:
determine a rank for candidate component based on the predicted phenotypic outcome, wherein selection of the candidate component is further based on the determined rank.

41. The system of claim 34, the one or more processors further configured to:
determine a robustness score based on the sensitivity analysis, wherein selection of the candidate component is further based on the robustness score and a predefined cutoff value.

42. The system of claim 34, the one or more processors further configured to:
determine a second optimal characteristic for each of the plurality of components based on the determined sensitivity.
